(19) United States
(12) Patent Application Publication
(10) Pub. No.: US 2006/0194596 A1
(43) Pub. Date: Aug. 31, 2006

(54) System and method for direct peer to peer mobile messaging

(76) Inventor: Li Deng, San Jose, CA (US)

Correspondence Address: Li Deng, 1047 S. Blaney Ave, San Jose, CA, 95129, US

(21) Appl. No.: 11/067,050

(22) Filed: Feb. 26, 2005

(51) Int. Cl. H04Q 7/20

(52) U.S. Cl. 455/466

(57) ABSTRACT

A method and system for enabling mobile users using wireless devices such as mobile phones to conduct real time direct peer to peer mobile messaging through mobile networks. The system and method of the present invention provides mobile messaging software running on mobile devices. The mobile messaging software has local storage for buddy list and presence management. Presence manager enables the mobile user to know buddy's status in real time. Each buddy at runtime contains at least two components: mobile phone/device number and online status. The mobile messaging software provides the functions for users to manage buddy list. The mobile messaging software of the present invention also provides functions to send, receive, and display messages in real time. The mobile messaging software of the present invention also provides function to conduct group messaging. The session management of the present invention enables mobile users to conduct conversations on mobile devices. Mobile users can use the mobile messaging software to invite buddies to join buddy list or respond to invitations. The system and method of the present invention also provides an optional server database to manage, backup and synchronize buddy lists on mobile devices. The mobile messaging software of the present invention may also provide the function for mobile user to disclose location.

### FIELD OF THE INVENTION

The present invention relates generally to wireless mobile devices on mobile networks, and more particularly but not exclusively to providing a system and method to conduct real time direct peer to peer mobile messaging and conversations.

### BACKGROUND OF THE INVENTION

Wireless technologies have exploded over the past few years and mobile computing devices are becoming increasingly more powerful. The greatest manifestation is the glue between unwired universes to the Internet domain and the advent of client application capabilities. The newest versions of mobile wireless devices are capable of running powerful applications developed using apis such as j2me, brew, symbian, and windows ce platform.

Mobile phone network infrastructures provide standard ways to pass text messages between phones. The most well-known mobile phone messaging protocols is SMS (Short Message Service). Peer to peer SMS is a powerful data transmission mechanism. However its use has been largely limited to sending or receiving one message at a time. There is no system and method that makes it possible for real time continuous messaging or chatting using this very efficient SMS communication mechanism. There is no system and method that provides an integrated buddy list and presence management using SMS protocol as the message transmission conduit to enable real time direct mobile to mobile messaging. The potential of SMS is under tapped.

The objective of present invention is to use standard mobile network transmission mechanism, such as SMS and the like, coupling with an integrated buddy list, presence management and session management to enable one to one, one to many real-time direct messaging and conversations between mobile devices via mobile networks.

### SUMMARY OF THE INVENTION

The invention described herein generally operates over a wireless network, such by way of example a SMS-enabled network to permit wireless communication via SMS protocol. It is understood that SMS-enabled wireless network is only one exemplary type of wireless communication networks capable of being used in connection with the present invention. It will be further understood that SMS-enabled devices are only one exemplary type of wireless communication devices capable of being used in connection with the present invention. Those of skill in the art will recognize that any wireless data communication technology now known or hereafter developed may be used in connection with the exemplary embodiments of the invention described herein. The invention described herein can be extended to any wireless data communication technology now known or hereafter developed.

Generally speaking, exemplary embodiments of the present invention enable mobile phone/device users to conduct peer to peer one to one, or one to many real-time mobile SMS messaging/chats. The messages are delivered by mobile messaging software of the present invention via SMS protocol. By eliminating the need to pass messages through a server and looking up recipient phone/carrier info, the mobile phone/device users can send and receive messages in a much more efficient way, which enables real-time messaging and conversations. The mobile messaging software of the present invention uses the phone/device number or MSISDN to identify entries in the buddy list. This greatly simplifies buddy list management and therefore increases the usability of real time messaging and chatting among mobile phones/devices.

According to an exemplary embodiment, a method of enabling real time mobile messaging/chatting among mobile phone/device users, generally involves an instance of the mobile messaging software of the present invention running on one device to communicate with one or more instances of the same software running on different mobile devices via SMS messaging protocol so as to enable real time SMS messaging among mobile phone/device users. When the mobile messaging software is installed, the software registers itself to handle SMS messages arriving at a specific SMS port. If the software is running, it listens and monitors SMS messages at the specified SMS port. If the mobile messaging software is not running, it will be waked up if a SMS message arrives at the specified port.

The session management of the present invention enables mobile users continuous messaging and conversations. A messaging session starts when a mobile user selects an online buddy from the buddy list and sends a SMS message. The recipient can send a response message back to establish a session. Once the session is established, the mobile messaging software of the present invention enables all the parties in the session to conduct continuous messaging and conversations without specifying the buddy's phone number again. The mobile messaging software manages the sessions by binding two or more phone numbers together. The mobile messaging software of the present invention also allows mobile users to send SMS messages to phone numbers not in the buddy list. The messages targeted to non buddies will be sent to SMS inbox of the mobile devices.

The mobile messaging software has local buddy list and presence management which enables mobile users to know the online status of buddies. Each buddy contains at least two elements: phone number and online status. The mobile messaging software provides mobile users the functions to add, delete, or modify buddy list locally. Buddy list can also be managed, backed up and synchronized from an optional server database.

The mobile messaging software of the present invention also provides function to invite friends to join buddy list. It also provides function to respond to an invitation. An invitation or response is also sent via SMS message.

A mobile user also has the option to disclose locations using the mobile messaging software of the present invention via SMS message.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 is an overview of system architecture in accordance with an exemplary embodiment of the present invention;

FIG. 2 illustrates a logical flow diagram generally showing one embodiment for managing invitation and response process of adding a new buddy into buddy list;

FIG. 3 illustrates a logical flow diagram generally showing one embodiment for managing session creation process;

FIG. 4 illustrates a logical flow diagram generally showing one embodiment for managing presence of the present invention;

FIG. 5 illustrates a logical flow diagram generally showing one embodiment for managing Buddy List and Synchronization Process.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, un recited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

The present invention relates generally to wireless mobile devices on mobile networks to conduct real time direct peer to peer continuous mobile messaging using various wireless data transmission protocols. The most well-known wireless data transmission protocols are SMS, MMS and WAP. To make the present invention easier to understand, SMS is used as one embodiment for various wireless data transmission protocols. However, the invention described herein can be extended to any wireless data communication protocol now known or hereafter developed.

Generally, mobile device may include virtually any portable computing device capable of connecting to another computing device to send or receive a message. Mobile device may also include other devices, such as Personal Digital Assistants (PDAs), microprocessor-based or programmable consumer electronics, wearable computers, and the like.

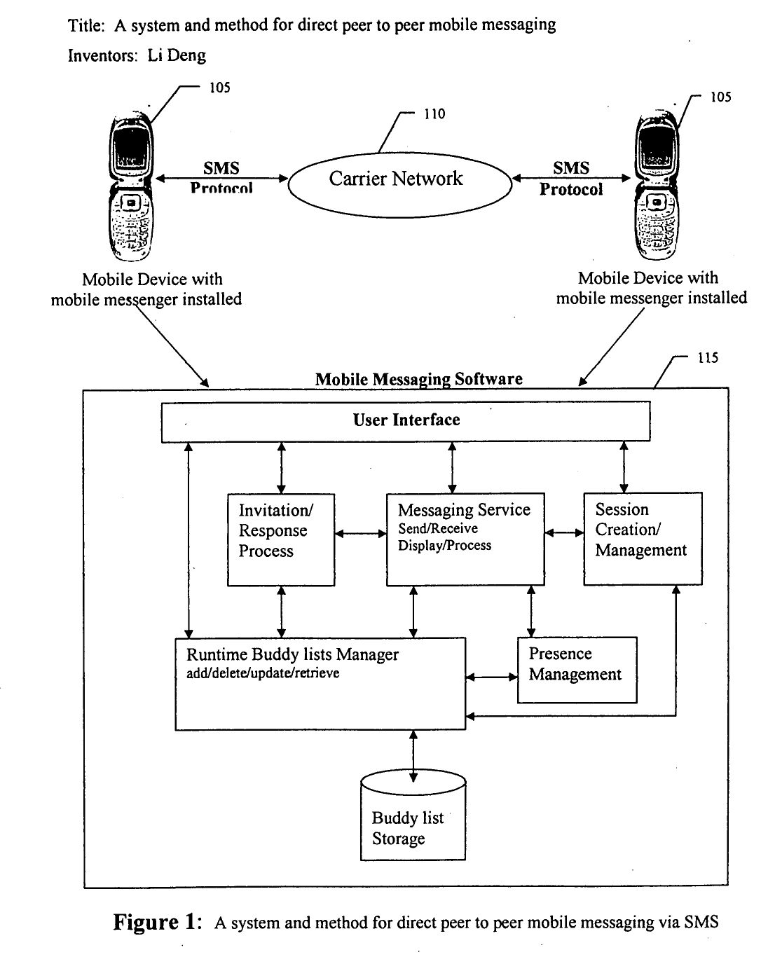

As exemplary embodiments of the present invention in FIG. 1, there is shown and described SMS messaging system and method for exchanging SMS messages among mobile user peers. Unlike existing SMS exchanges, which simply send or receive one message at a time, the SMS message system of present invention binds parties involved in the message exchange into a session, so that real time conversations can take place among involved parties using the very efficient SMS messaging protocol. This SMS message system is enabled by mobile messaging software running on a mobile device communicating directly with another instance of the same mobile messaging software running on the other mobile device. One very important feature of the present invention is that, in one embodiment, the mobile messaging software functions as both a SMS-based client and a SMS-based server at the same time. The SMS-based client sends out-going SMS messages. The SMS-based server automatically receives, processes, and displays incoming SMS messages for the application. Unlike traditional HTTP servers, SMS-based servers do not rely on the IP network. The Server addresses are identified by mobile device numbers and specified SMS port.

When the mobile messaging software is installed in a mobile device 105, the software registers itself to handle SMS messages arriving at a specific SMS port on the mobile device 105. If the software is running, it listens and monitors SMS messages at the specified SMS port. If the mobile messaging software is not running, it will be waked up if there is a SMS message arriving at the specified port. Mobile messaging software 115 installed on a mobile device 105 is generally in communicating with other instances of mobile messaging software registered on the same port and running on other devices through a mobile carrier network 110.

FIG. 1 shows one embodiment of mobile messaging software of the present invention. Mobile messaging software 115 may include more or less components than those shown. The components shown, however, are sufficient to disclose an illustrative embodiment for practicing the invention. Mobile messaging software 115 in FIG. 1 includes a User Interface component, Invitation/Response component, Messaging Service component, Session Creation/Management component, Runtime Buddy list management component, Presence management component, and Buddy list persistent storage.

Generally speaking, a mobile user interacts with the mobile messaging software through the User Interface component. The User Interface component then communicates with different components to accomplish different tasks to enable real time direct peer to peer continuous mobile messaging and conversation. Messaging service component is at the center of the diagram, which handles send, receive and process of all the messages. Messaging service component provides messaging services to all the other components. For example, messaging service component and User Interface component work together to display and read incoming messages. Another important component in the diagram is the buddy list manager. Buddy list manager is the only component with access to buddy list storage. Buddy list manager handles the entire add/delete/update/retrieve requests from other components. Presence management component and buddy list manager component enable mobile users to know their buddy's online status. With the help of messaging service and buddy list manager, invitation/response process invites new buddies and responses to buddy invitations. With the help of messaging service and buddy list manager, session creation/management component manages all the live sessions from creation to exit.

The mobile messaging software of the present invention enables users to create one or many buddy lists. Each buddy list is constructed as either a flat structure or a tree structure with each node as either a buddy or a buddy list. Each buddy contains at least two components: mobile phone/device number and status, where mobile phone/device number is stored in buddy list storage and status is dynamically generated at runtime. Each buddy may contain more components such as nick name.

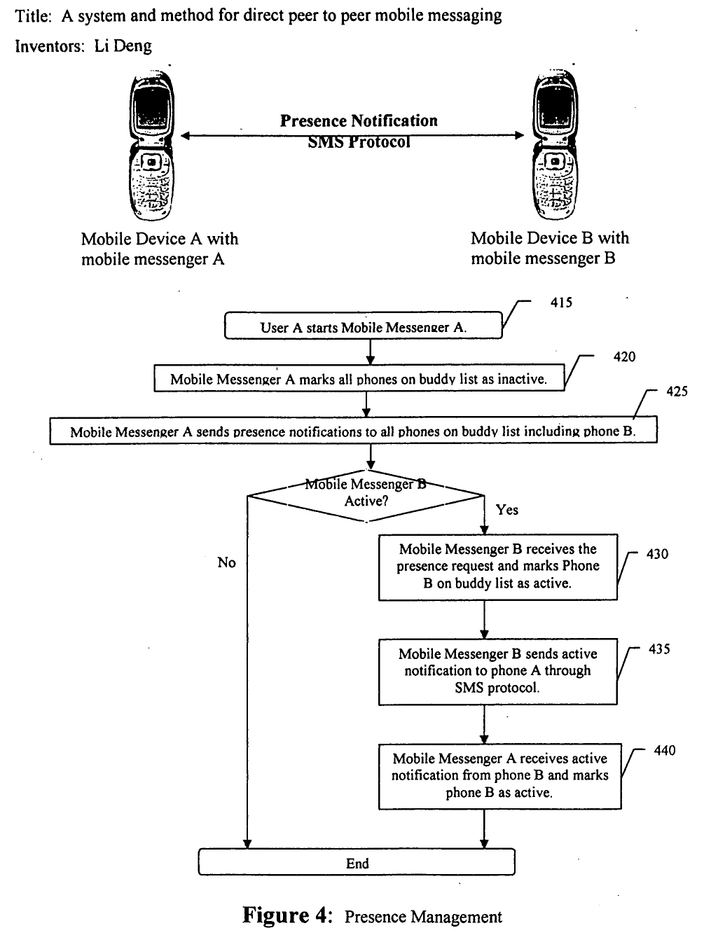

An embodiment of the present invention provides presence management functionality which enables mobile users to know the status of buddies. Whenever a mobile user changes the status, the mobile messaging software notifies its online buddies that the mobile user's status has been changed. These notifications can be initiated either by the mobile user or the mobile messaging software. For example, the mobile messaging software initiates the notification when the mobile user starts or exits the mobile messaging software. Whenever a mobile user starts the mobile messaging software, the mobile messaging software notifies all buddies through SMS message that the mobile user is now online. Whenever a mobile user closes the mobile messaging software, the mobile messaging software also notifies through SMS online buddies that the mobile user is now offline. The mobile user also can initiate the notification by changing the status from ready to busy. As an exemplary implementation, a server component may be introduced to assist the presence management. When a mobile user starts the mobile messaging software of the present invention, a presence notification will be sent to the server. The server will mark the phone number as online and send back the list of online buddies. The mobile messaging software then sends a presence message to all the online buddies through SMS protocol. When the mobile messaging software exits, an exit message will be sent to server again so that server knows it is no longer online. An exit SMS message is also sent by the mobile messaging software directly to all the online buddies so that the status can be updated on their respective buddy lists. As an alternative exemplary implementation in FIG. 4, when a mobile user starts the mobile messaging software of the present invention, an online SMS message is sent to all the buddies in the buddy list. If a buddy is online, the mobile messaging software on buddy's mobile device will update the online status of the sender and respond to the sender. Upon receiving the acknowledgment, the mobile messaging software running on sender's mobile device then updates the status of the buddy to online. When mobile messenger goes offline, an offline SMS message is also sent directly to all the online buddies so that the status can be updated on their respective buddy lists.

FIG. 4 is a flow diagram generally showing one embodiment for a process of managing presence of the present invention. The process 400 begins at block 415, where user A starts the mobile messenger A of the present invention. The mobile messenger A then marks all buddies in the buddy list as offline at block 420. To facilitate discussion, let us take user B as an exemplary buddy. User A then sends the presence message to all the phones including user B's phone in the buddy list at block 425. If user B is running the mobile messenger B on user B's mobile device, mobile messenger B receives the presence notification and marks Phone A in the buddy list as online at block 430. Mobile Messenger B then sends a response message back to mobile messenger A to indicate its online status at block 435. Mobile messenger A receives online response from phone B and marks phone B as an online buddy at block 440. If a buddy is not online, no response will come back to mobile messenger A and the offline status will remain.

An embodiment of the present invention allows mobile users to invite friends to join his/her buddy list or response to invitation using the mobile messaging software. An invitation is also sent via SMS message. By way of example only, user A can enter user B's phone number and type in a greeting message to ask user B to be his peer to peer buddy. The mobile messaging software then sends a message to user B's mobile device. The message is tagged for invitation purpose. When the message arrives at SMS-based server on user B's mobile device, the mobile messaging software on user B's device parses the message and prompts user B for approval. If user B accepts the invitation, a system approval SMS message will be sent back to user A's mobile device. User B's phone number and status will be added to user A's buddy list. User A's phone number will be added to user B's buddy list as well.

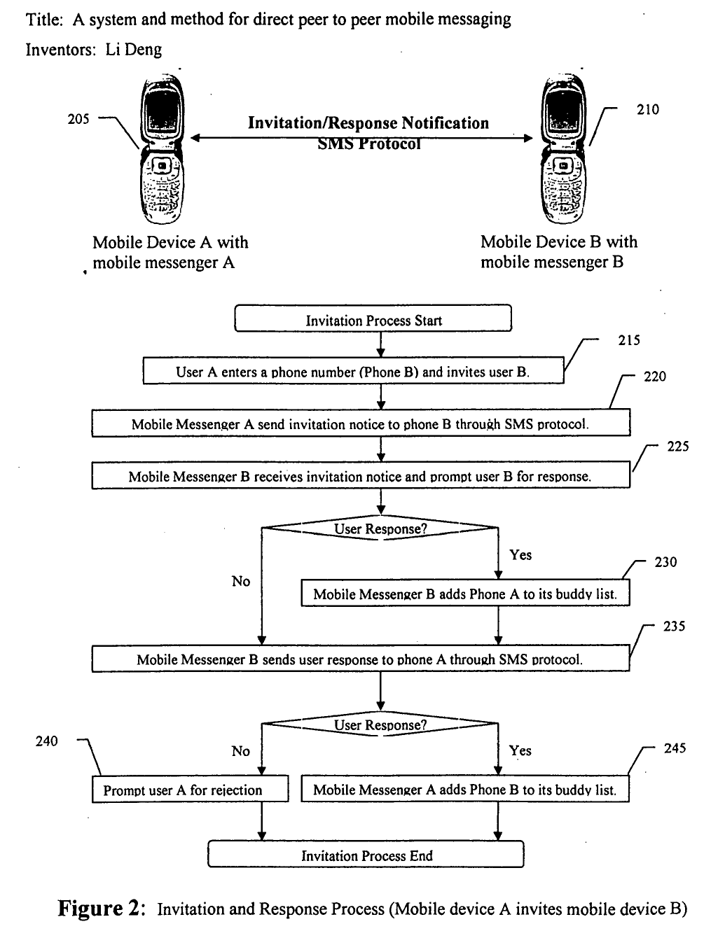

FIG. 2 is a flow diagram generally showing one embodiment of a process for managing invitation and response processes to add a new buddy to buddy list. The process 200 begins, after a start block, at block 215, where user A interacts with the mobile messenger A of the present invention to enter user B's phone number to invite user B to become user A's buddy. User A then sends the invitation to user B's phone number at block 220. User B then uses the mobile messenger B of the present invention to receive the invitation message at block 225. Upon receiving the invitation message, user B then decides whether to accept the invitation. If the invitation is accepted, the mobile messenger B adds phone A into its buddy list at block 230. Mobile messenger B then sends user B's response to mobile messenger A at block 235. Upon receiving a positive response, mobile messenger A adds phone B into its buddy list at block 245. If the invitation is rejected, mobile messenger A notifies user A for rejection at bock 240.

An embodiment of the present invention provides session creation/management functionality which enable mobile users to conduct continuous peer to peer messaging. A messaging session starts when a mobile user selects one or more online buddies from his buddy list and sends a short text message. The SMS message will be picked up and processed by the recipient mobile messaging software of current invention. The recipient can respond to the message by sending a response message back. A messaging session is then established on each of the involved mobile devices. Each session inclueds at least two components: session ID and one or more phone numbers. The mobile messaging software manages the sessions by binding one or more phone numbers together. Once the session is established, the mobile messaging software of the present invention enables all the parties in the session to conduct continuous messaging and conversation without specifying the buddy's phone number. The session information may be embedded in the SMS messages. For example, when an SMS message is sent to start a conversation, the sender's phone number and SMS sever port are sent as part of the message. On the receiving end, the mobile user just need to enter a message and press send to carry on the conversation. When user exit the mobile massager software, all live sessions will be ended. Mobile users can also end a particular session.

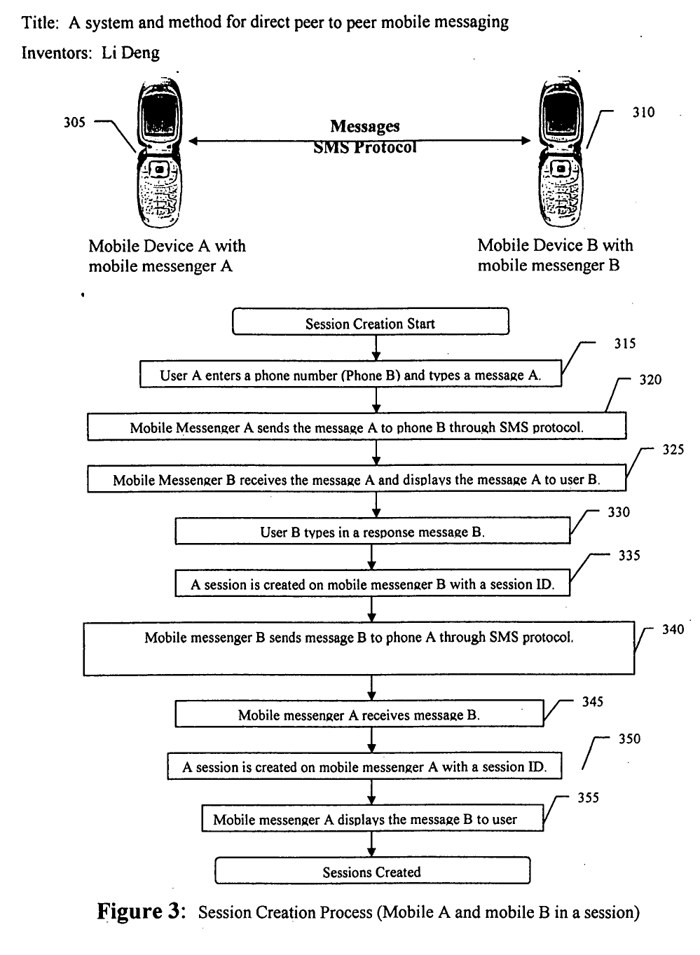

With reference to FIG. 3, there is shown and described an exemplary method of interaction between the mobile messaging software and a mobile user that enables the user to start a conversation session. By way of example only, user A can pick up one or multiple entries from the buddy list, type a text message and send the message via SMS protocol to the recipients. On the receiving end, upon receiving a message, user B can respond to the message by sending back a message via the same SMS protocol. After a conversation session is established, user A and user B can continue the conversation by exchanging more messages without specifying each other's phone number again.

FIG. 3 is a flow diagram generally showing one embodiment for a process of managing session creation process. The process 300 begins, after a start block, at block 315, where user A interact with the mobile messenger A of the present invention to pick up user B's phone number from its buddy list and enter a message. User A then sends the message to user B's phone number at block 320. User B then uses the mobile messenger B of the present invention to receive the message at block 325. Upon receiving the message, user B then interacts with the mobile messenger B to enter a response message at block 230. Mobile messenger B then creates a session ID and saves it at block 325. Mobile messenger B then sends response message back to mobile messenger A at block 340. Mobile messenger A receives response message at block 345. Mobile messenger A then creates a session ID and saves it at block 350. Mobile messenger A finally displays the response message at block 355.

The system and method of the present invention also provides functionalities to manage, backup, and sync buddy lists. A user can interact with the mobile messaging software locally to add, delete, and modify buddy list through buddy list manager. Buddy list manager component accesses the buddy list storage and manages buddy list at runtime. Buddy list can also be managed, backed up and synchronized from an optional server database. Buddy list can be pushed or pulled between server database and mobile messaging software regularly or at user's request. User may request to synchronize buddy list in both direction from either PC or mobile device. As an exemplary implementation, a sever database and an HTTP interface are provided. Buddy list will be uploaded to server database whenever there is change of buddy list on the mobile messaging software. Buddies can also be added, modified, and deleted via an HTTP interface using a PC browser. Changes made from a PC interface will be pushed to mobile messaging software. Buddy list can also be sent to a server database regularly for backup and synchronization.

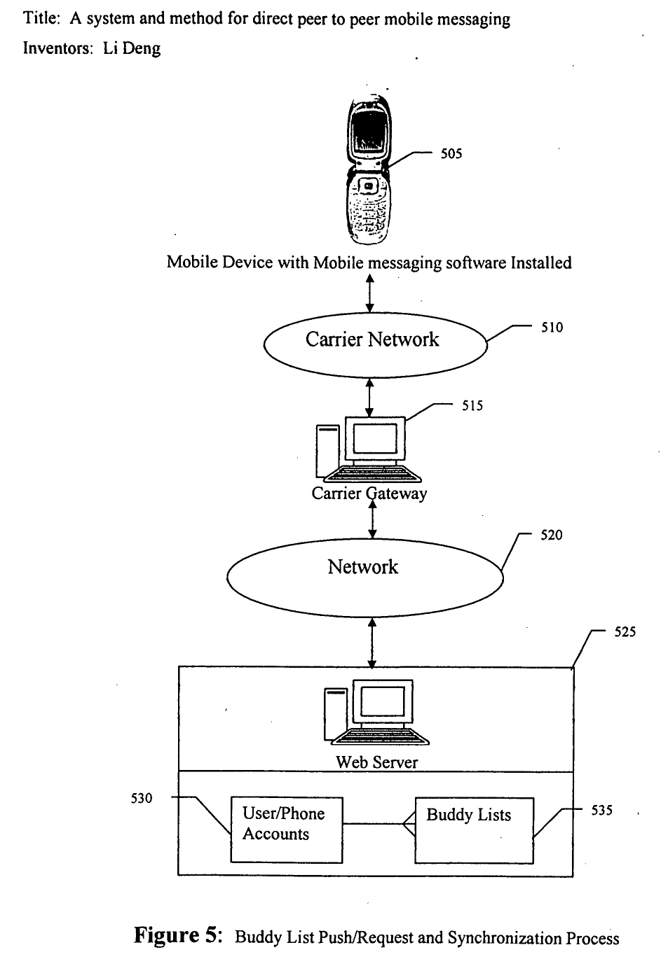

FIG. 5 is a flow diagram generally showing one embodiment for a process of backup and synchronization of buddy lists between the messenger software and server database. Mobile messenger of mobile phone 505 sends its phone number and buddy list through carrier network 510, carrier gateway 515 and internet 520 to web server 525. Web server 525 will update the buddy list for the specified mobile phone 505. Mobile messenger of mobile phone 505 can also request its buddy list through carrier network 510, carrier gateway 515 and internet 520 from web server 525. Upon receiving the request, web server 525 will provide the buddy list for the specified mobile phone 505. The similar push/request can also be initiated from web server 535.

The optional location management of the present invention allows mobile users to have the option to disclose locations. This function is enabled using GPS functions. Mobile users can set the level of disclosure to always disclose, never disclose and always prompt.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A method and system for enabling mobile users using wireless devices such as mobile phones/devices to conduct real time direct peer to peer mobile messaging via standard mobile network data transmission mechanism, such as SMS and the like, the system comprising:
Buddy lists and buddy list management on the mobile devices;
Messaging sessions and session management for real time one to one or one to many mobile conversations;
Sending messages via mobile networks directly from one mobile device to one or many mobile devices to enable mobile conversations;
Listening, monitoring, receiving, and processing incoming messages using a mobile communication port, such as a SMS port and the like;
Inviting friends to become buddies via direct mobile message;
Accepting buddy invitations via direct mobile message;
Presence and presence management of buddies;
Optional location disclosure via direct mobile message.

2. The method of claim 1, wherein a mobile messenger handles one to one and one to many real time mobile messaging using standard mobile network data transmission mechanism, such as SMS and the like.

3. The method of claim 1, where messages exchanged between two mobile devices is purely mobile to mobile on mobile networks. It involves one instance of mobile messenger running on a mobile device communicating directly with another instance of the same mobile messenger running on the other mobile device;

4. The method of claim 1, wherein the mobile messenger functions as both client for sending messages and server for receiving messages;

5. The method of claim 1, wherein the mobile messenger registers itself during installation to handle messages arriving at a particular communication port, such as a SMS port.

6. The method of claim 1, wherein the mobile messenger functions as a messaging server that listens, monitors, receives, and processes incoming messages at a specified communication port, such as a SMS port.

7. The method of claim 6, wherein the messaging server address is identified by mobile phone/device numbers and the specified communication port. Unlike traditional HTTP servers, the messaging servers do not rely on the IP network.

8. The method of claim 1, wherein the mobile messenger as a messaging client sends outgoing messages to a messaging server address via mobile networks.

9. The method of claim 1, wherein the mobile messenger managing buddy list further comprising;
Adding, removing or modifying, rearranging using the mobile messenger;
Managing a buddy list with nodes which may also be lists of buddies;
Managing a buddy list with zero buddies.

10. The method of claim 1, wherein each buddy in buddy list has at least one entry: mobile device number. The identity for each buddy is the mobile device number.

11. The method of claim 1, wherein each buddy at runtime contains at least 2 components: mobile device number and online status.

12. The method of claim 1, wherein mobile conversations among mobile peers are enabled through sessions. Sessions are established by binding mobile peers using mobile device numbers such as mobile phone numbers. Each incoming or outgoing message can be associated with a session using the originating and destination mobile phone/device numbers.

13. The method of claim 1, wherein session management methods further comprise:
Starting a session by sending a message to a buddy;
Establishing a session by responding to a new message from a mobile device number which is not in any live session;
Ending a session by closing or exiting the mobile messenger.

14. The method of claim 1, wherein mobile messenger can send messages to any number of recipients or groups in the buddy list.

15. The method of claim 1, wherein invitations or responses to invitations are also delivered as direct mobile to mobile messages.

16. The method of claim 1, wherein the mobile messenger manages the online status of buddies:
Setting the initial online status as offline;
Sending system query message to all the buddies;
Updating the online status of buddy upon receiving acknowledgements.

17. The method of claim 1, wherein the mobile messenger may provide function for users to disclose location to other users by sending direct peer to peer mobile messages.

18. The system of claim 1, wherein a server for assisting the buddy list management and presence management further comprising:
Storing the buddy lists of all the users identified by mobile device numbers;
Providing tools for users to manage buddy lists from PC browser;
Synchronizing buddy list with mobile messenger in both directions;
Backing up buddy list from mobile messenger.

19. The method of claim 18, wherein the server
Keeps records of online status of all the users at real time;
Provides the online status of the buddies to mobile messenger upon request from mobile messenger.

20. The method of claim 1, wherein the mobile messenger may manage the online status of buddies with the assistance of a server further comprising:
Querying a server database to get presence info;
Updating the online status of buddy accordingly.
